(19) United States
(12) Patent Application Publication
(10) Pub. No.: US 2009/0262843 A1
(43) Pub. Date: Oct. 22, 2009

(54) MIMO Slow Precoding Method and Apparatus

(76) Inventors: Leonid Krasny, Cary, NC (US); Dennis Hui, Cary, NC (US)

Correspondence Address: COATS & BENNETT, PLLC, 1400 Crescent Green, Suite 300, Cary, NC, 27518, US

(21) Appl. No.: 12/105,313

(22) Filed: Apr. 18, 2008

(51) Int. Cl. H04L 27/28

(52) U.S. Cl. 375/260

(57) ABSTRACT

Pre-coder techniques disclosed herein are based on long-term statistical channel information for reducing channel feedback overhead and transmitter complexity. In an embodiment, a receiver includes two or more receive antennas spaced approximately λ/2 apart and a baseband processor. The baseband processor computes channel correlations for different combinations of transmit antennas and each receive antenna and averages the channel correlations over the different receive antennas to form a frequency-independent channel correlation matrix. The baseband processor also computes a scalar representing noise variance at the receive antennas and feeds back the frequency-independent channel correlation matrix and the scalar for use in performing transmitter pre-coding computations.

### TECHNICAL FIELD

The present invention generally relates to pre-coding, and particularly relates to slow pre-coding in MIMO wireless communication systems.

### BACKGROUND

Pre-coding is a technique for supporting multi-layer transmission in MIMO (multiple-input, multiple-output) radio systems. Pre-coding involves optimally focusing the power and direction of transmit antennas to improve signal quality reception. The transmit antennas can be optimally focused by matching pre-filter weights to channel and noise conditions. This way, multiple signal streams can be emitted from the transmit antennas with independent and appropriate weighting such that link throughput is maximized at the receiver.

The pre-filter weights are determined based on channel feedback information periodically received at the transmitter. In a pre-coded MIMO OFDM (orthogonal frequency division multiplexing) system with n_{T} transmit antennas and n_{R} receive antennas, the input-output relationship can be described as:

Y(f)=G(f)W(f)S(f)+N(f), fε[1, Nf] (1)

where Y(f) is an n₁×1 received signal vector, G(f) is an n_{R}×n_{T} channel response matrix, W(f) is an n_{T}×Ns pre-coding matrix, S(f) is an Ns×1 vector of the transmitted streams, N(f) is an n_{R}×1 noise (including interference) vector based on an n_{R}×n_{R} noise correlation matrix Kₙ(f), Nf represents the number of OFDM sub-carriers and Ns represents the number of transmitted streams. Optimal performance of the MIMO system is achieved when ideal channel state information is available at the transmitter and the pre-coding matrix W(f) is designed based on the eigenvectors of an instantaneous whitened channel correlation matrix H(f) of the form:

H(f)=G^{H}(f)Kₙ⁻¹(f)G(f) (2)

where Kₙ⁻¹(f) is the inverse of the noise correlation matrix Kₙ(f).

However, the channel response is usually known to the receiver only through reference signals periodically sent by the transmitter on the forward link. The channel response as observed by the receiver is explicitly fed-back to the transmitter on the uplink (i.e., receiver-to-transmitter). Such channel response feedback typically includes n_{T}×n_{R}×Nf complex channel coefficients and often consumes significant uplink overhead, especially for LTE (long term evolution) OFDM systems having a large frequency band (i.e., a large number of Nf sub-carriers). Moreover, channel response feedback information in closed-loop MIMO systems typically changes at the fast fading rate, requiring more frequent use of uplink resources for transmitting the channel information in a timely manner.

Some conventional pre-coders are based only on long-term statistical channel information. These types of pre-coders obtain the pre-coding matrix W(f) by calculating the eigenvectors of an averaged whitened channel correlation matrix \tilde{H}(f) as given by:

\tilde{H}(f)=E{H(f)} (3)

where E{•} represents statistical averaging. Substituting Equation (2) into Equation (3) yields the following expression for the elements of matrix \tilde{H}(f):

$$\begin{matrix}\tilde{H} ( f ; {m}_{1} , {m}_{2} ) = {\sum }_{{i}_{1} = 1}^{{n}_{R}} {\sum }_{{i}_{2} = 1}^{{n}_{R}} {K}_{G} ( {m}_{1} , {m}_{2} , {i}_{1} , {i}_{2} ) {K}_{n}^{- 1} ( f ; {i}_{1} , {i}_{2} ) \\ where & ( 4 ) \\ {K}_{G} ( {m}_{1} , {m}_{2} , {i}_{1} , {i}_{2} ) = E \{ G ( f ; {m}_{1} , {i}_{1} ) {G}^{*} ( f ; {m}_{2} , {i}_{2} ) \} & ( 5 )\end{matrix}$$

is the statistical correlation between downlink (i.e., transmitter-to-receiver) channels G(f; m₁, i₁) and G(f; m₂, i₂). Downlink channel G(f; m₁, i₁) describes signal propagation from transmit antenna m₁ to receive antenna i₁. Downlink channel G(f; m₂, i₂) similarly describes signal propagation from transmit antenna m₂ to receive antenna i₂.

It is known that the statistical channel correlations K_{G}(m₁, m₂, i₁, i₂) do not depend of frequency, as shown in Equation (5). Moreover, the whitened channel correlation matrix \tilde{H}(f; m₁, m₂) of equation (4) is not based on instantaneous channel state information as is H(f) of equation (2). Thus, \tilde{H}(f; m₁, m₂) is usually more stable and varies at a slower rate than H(f). Accordingly, uplink resources are needed less often to feedback the slow pre-coding matrix \tilde{W}(f) as compared to its instantaneous counterpart W(f).

However, even though the pre-coding matrix \tilde{W}(f) is transmitted less often, a significant amount of uplink resources are still needed each time the channel feedback information is transmitted because \tilde{W}(f) is frequency dependent. The amount of channel feedback information for MIMO OFDM systems is a function of the number of frequency sub-carriers employed. Accordingly, less uplink resources are available for uplink data communication when more sub-carriers are used. In addition, implementing \tilde{W}(f) as the pre-coding matrix at the transmitter requires a set of n_{T}×Ns pre-filters, increasing base station complexity.

### SUMMARY

According to the methods and apparatus disclosed herein, pre-coder techniques based on long-term statistical channel information are described that reduce channel feedback overhead and base station complexity. The receive antennas of the MIMO system are spaced approximately λ/2 apart (where λ is wavelength). Under these conditions, channels between the receive antennas become effectively uncorrelated. As such, statistical correlations between different downlink channels can be computed for different ones of the transmit antennas and each receive antenna. By doing so, the channel correlations can be averaged over the different receive antennas to form a frequency-independent channel correlation matrix. Moreover, the noise variance is computed as a scalar and not a matrix. Employing a frequency-independent channel correlation matrix reduces how often the channel information is reported. Using a scalar to represent noise variance instead of a matrix decreases the amount of channel state feedback and thus the number of pre-filters used at the transmitter, reducing base station complexity.

In one embodiment, a method of feeding-back channel quality information from a receiver having two or more receive antennas spaced approximately λ/2 apart to a transmitter having two or more transmit antennas includes computing channel correlations for different combinations of the transmit antennas and each receive antenna. The channel correlations are averaged over the different receive antennas to form a frequency-independent channel correlation matrix. A scalar is computed representing noise variance at the receive antennas. The frequency-independent channel correlation matrix and the scalar are fed back for use in performing transmitter pre-coding computations such determining pre-filter weights using a pre-coding matrix. In one embodiment, the receiver computes a pre-coding matrix based on the frequency-independent channel correlation matrix and the scalar, e.g., by taking the eigenvectors of the correlation matrix. The pre-coding matrix is then sent to the transmitter. In another embodiment, the receiver computes a whitened channel correlation matrix from the frequency-independent channel correlation matrix and the scalar. The whitened channel correlation matrix is sent to the transmitter for pre-coding matrix computation. In each of these embodiments, pre-filter weights at the transmitter are set based on the pre-coding matrix.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of an embodiment of a MIMO OFDM wireless communication system.

FIG. 2 is a flow diagram of an embodiment of program logic for feeding-back channel quality information in a MIMO OFDM wireless communication system.

FIG. 3 is a flow diagram of an embodiment of program logic for setting transmitter pre-filter weights based on channel quality feedback information.

### DETAILED DESCRIPTION

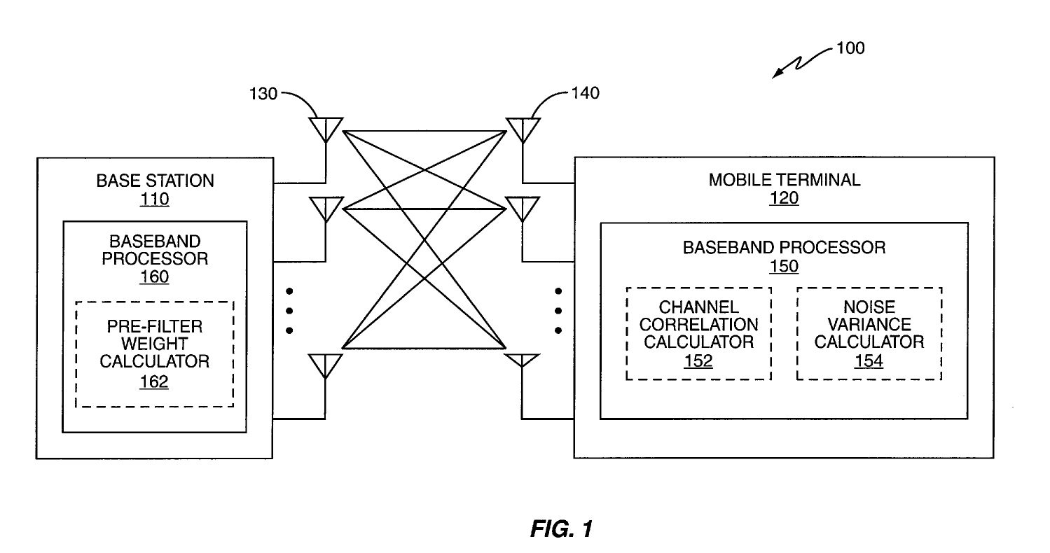

FIG. 1 illustrates an embodiment of a MIMO OFDM wireless communication system 100 including a transmitter 110 such as a base station that services one or more wireless receivers 120 such as a mobile terminal. The transmitter 110 has two or more transmit antennas 130 for transmitting signal streams over downlink communication channels to the receiver 120 using a plurality of frequency sub-carriers. The receiver 120 similarly has two or more receive antennas 140 for receiving the transmitted signal streams. The receiver 120 includes a baseband processor 150 for processing the received signal streams, including channel response estimation. To this end, the baseband processor 150 includes a channel correlation calculator 152 and a noise variance calculator 154 for estimating the downlink channel response.

It can be shown that when the receive antennas 140 are spaced approximately λ/2 apart (i.e., λ/2 wavelength spacing), the channels between the antennas 140 become effectively uncorrelated. Under these receive antenna spacing conditions, equation (5) can be expressed as:

K_{G}(m₁, m₂, i₁, i₂)=K_{TX}(m₁, m₂, i₁)·δ(i₁−i₂) (6)

where

K_{TX}(m₁, m₂, i)=E{G(f; m₁, i)G*(f; m₂, i)} (7)

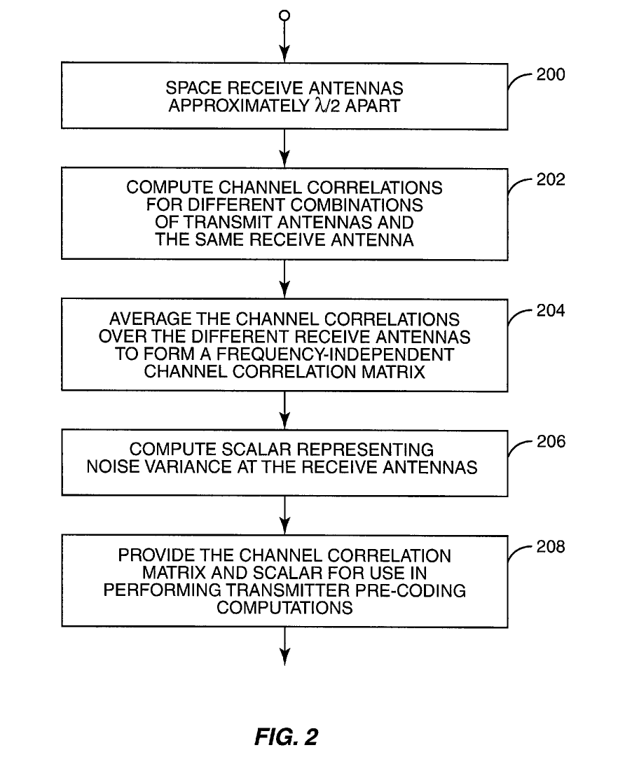

is the statistical correlation between downlink channels G(f; m₁, i) and G(f; m₂, i). The first downlink channel G(f; m₁, i) describes signal propagation from transmit antenna m₁ to the i^{th} receive antenna 140. The second downlink channel G(f; m₂, i) similarly describes signal propagation from transmit antenna m₂ to the same i^{th} receive antenna 140. Broadly, the channel correlation calculator 152 computes channel correlations K_{TX}(m₁, m₂, i) for different combinations of the transmit antennas 130 and each receive antenna 140, e.g., as illustrated by Step 202 of FIG. 2.

Substituting equation (6) into equation (4) yields a whitened channel correlation matrix given:

$$\tilde{H} ( f ; {m}_{1} , {m}_{2} ) = {\sum }_{i = 1}^{{n}_{R}} {K}_{TX} ( {m}_{1} , {m}_{2} ; i ) {K}_{n}^{- 1} ( f ; i , i ) \qquad ( 8 )$$

The channel correlation calculator 152 computes the frequency-independent channel correlation matrix

$${\sum }_{i = 1}^{{n}_{R}} {K}_{TX} ( {m}_{1} , {m}_{2} ; i )$$

by averaging the channel correlations K_{TX}(m₁, m₂, i) over the n_{R} receive antennas 140, e.g., as illustrated by Step 204 of FIG. 2. In addition, the noise variance estimator 154 considers noise variance at the different receive antennas 140 to be approximately the same. Thus, equation (8) has the form:

$$\begin{matrix}\tilde{H} ( f ; {m}_{1} , {m}_{2} ) = α ( f ) {\sum }_{i = 1}^{{n}_{R}} {K}_{TX} ( {m}_{1} , {m}_{2} ; i ) \\ where & ( 9 ) \\ α ( f ) = {K}_{n}^{- 1} ( f ) & ( 10 )\end{matrix}$$

and Kₙ⁻¹ are inverse noise (including interference) correlations computed by the noise variance calculator 154.

The whitened channel correlation matrix \tilde{H}(f; m₁, m₂) of equation (9) is thus the product of two terms. One term is the frequency-independent channel correlation matrix

$${\sum }_{i = 1}^{{n}_{R}} {K}_{TX} ( {m}_{1} , {m}_{2} ; i )$$

which does not depend on frequency, and thus can be reported less often. The other term α(f) is a noise variance scalar that is the same for all transmit antennas 130 and can be viewed as a pre-filter, e.g., as illustrated by Step 206 of FIG. 2. The frequency-independent channel correlation matrix

$${\sum }_{i = 1}^{{n}_{R}} {K}_{TX} ( {m}_{1} , {m}_{2} ; i )$$

and the noise variance scalar α(f) are provided to the transmitter 110 for use in performing pre-coding computations, e.g., as illustrated by Step 208 of FIG. 2.

According to one embodiment, the receiver 120 feeds back the terms to the transmitter 110 in the form of the whitened channel correlation matrix \tilde{H}(f; m₁, m₂) which is used by the transmitter 110 in pre-coding matrix computations. In another embodiment, the receiver 120 indirectly feeds back the terms to the transmitter 110 by computing a pre-coding matrix \tilde{W}(f) based on the whitened channel correlation matrix \tilde{H}(f; m₁, m₂) and transmitting the pre-coding matrix to the transmitter 110. In either case, the whitened channel correlation matrix \tilde{H}(f; m₁, m₂) can be derived from estimates of the frequency-independent channel correlation matrix

$${\sum }_{i = 1}^{{n}_{R}} {K}_{TX} ( {m}_{1} , {m}_{2} ; i )$$

and the noise variance term α(f).

In one embodiment, the channel correlation calculator 152 estimates the channel correlations K_{TX}(m₁, m₂, i) for different combinations of the transmit antennas 130 and each receive antenna 140. The channel estimates are long-term averaged over a plurality of frequency sub-carriers N_{f} and a plurality of time slots Nₜ as given by:

$${\hat{K}}_{TX} ( {m}_{1} , {m}_{2} , i ) = \frac{1}{{N}_{f} {N}_{t}} {\sum }_{f = 1}^{{N}_{f}} {\sum }_{t = 1}^{{N}_{t}} {\hat{G}}_{t} ( f ; {m}_{1} , i ) \cdot {\hat{G}}_{t}^{*} ( f ; {m}_{2} , i ) \qquad ( 11 )$$

where \hat{K}_{TX}(m₁, m₂, i) is the resulting channel correlation estimate and Ĝₜ(f; m₁, i) is an estimate of the channel between the m^{th} transmit antenna and the i^{th} receive antenna at time t.

The noise variance calculator 154 similarly estimates the noise correlations Kₙ(f; i₁, i₂) based on certain noise samples over pilot symbols for each frequency f. An estimate \hat{K}ₙ⁻¹(f; i₁, i₂) of the inverse noise correlations Kₙ⁻¹(f; i₁, i₂) can be obtained from the estimate of Kₙ(f; i₁, i₂). Substituting the inverse noise correlation expression into equation (10) provides:

\hat{α}(f)=\hat{K}ₙ⁻¹(f) (12)

Combining equations (11) and (12) yields an estimate of the whitened channel correlation matrix \tilde{H}(f; m₁, m₂) given by:

$$\hat{H} ( f ; {m}_{1} , {m}_{2} ) = \hat{α} ( f ) {\sum }_{i = 1}^{{n}_{R}} {\hat{K}}_{TX} ( {m}_{1} , {m}_{2} ; i ) \qquad ( 13 )$$

The pre-coding matrix \tilde{W}(f) can then be obtained based on eigenvectors of the channel response estimate matrix Ĥ(f; m₁, m₂) as given by:

$$\tilde{W} ( f ) = β ( f ) \cdot Ψ \\ where \\ β ( f ) = \frac{\hat{α} ( f )}{\sqrt{\int \hat{α} ( f ) d f}} \qquad ( 14 )$$

and Ψ are the eigenvectors of the matrix

$${\sum }_{i = 1}^{{n}_{R}} {\hat{K}}_{TX} ( {m}_{1} , {m}_{2} ; i ) .$$

This expression for the pre-coding matrix can also be obtained when noise at the receive antennas 140 is considered relatively spatially uncorrelated. Under these conditions, the noise correlation matrix Kₙ(f) has the form:

Kₙ(f)=diag{σ²(f; 1), σ²(f; 2), . . . , σ²(f;n_{R})} (15)

where σ²(f;i) is the noise variance at the i^{th} receive antenna.

Substituting equation (15) into equation (4) yields the whitened channel correlation matrix \tilde{H}(f; m₁, m₂) with elements given by:

$$\tilde{H} ( f ; {m}_{1} , {m}_{2} ) = {\sum }_{i = 1}^{{n}_{R}} \frac{1}{{σ}^{2} ( f , i )} {K}_{TX} ( {m}_{1} , {m}_{2} ; i ) \qquad ( 16 )$$

In one embodiment, the noise variance σ²(f;i) at the different receive antennas is considered to be approximately the same. Thus, the whitened channel correlation matrix \tilde{H}(f; m₁, m₂) becomes:

$$\tilde{H} ( f ; {m}_{1} , {m}_{2} ) = \frac{1}{{σ}^{2} ( f , i )} {\sum }_{i = 1}^{{n}_{R}} {K}_{TX} ( {m}_{1} , {m}_{2} ; i ) \qquad ( 17 )$$

which coincides with equation (9). Accordingly, the pre-coder expression of equation (14) can be viewed as an optimal slow pre-coder for spatially uncorrelated noise. This does not result in the MIMO system 100 ignoring real noise correlation between the receive antennas 140 because the receiver baseband processor 150 addresses noise correlation.

The pre-coder expression of equation (14) can be further simplified by averaging the channel response estimate matrix Ĥ(f; m₁, m₂) over frequency. The frequency-dependent noise variance scalar α(f) is also averaged over frequency to obtain a frequency-independent noise variance scalar α. Under these conditions, the pre-coding matrix \tilde{W}(f) of equation (14) reduces to:

\tilde{W}(f)=β·Ψ (18)

where β is selected to satisfy the transmitted power constraint.

The transmitter 110 uses the pre-coding matrix \tilde{W}(f) to optimally focus the power and direction of the transmit antennas 130. The transmit antennas 130 are optimally focused by matching pre-filter weights to channel and noise conditions represented by the pre-coding matrix \tilde{W}(f). In one embodiment, pre-filter weights for the transmit antennas 130 are set using the pre-coding matrix \tilde{W}(f). In more detail, the transmitter 110 includes a baseband processor 160. The transmitter baseband processor 160 decodes the feed back signal in order to reconstruct the pre-coding matrix \tilde{W}(f) computed by the receiver 120. Alternatively, the transmitter baseband processor 160 decodes the feedback signal to reconstruct the whitened channel correlation matrix \tilde{H}(f; m₁, m₂) received from the receiver 120. The whitened channel correlation matrix \tilde{H}(f; m₁, m₂) is computed by the receiver 120 based on the noise variance scalar α(f) or α and the frequency-independent channel correlation matrix

$${\sum }_{i = 1}^{{n}_{R}} {K}_{TX} ( {m}_{1} , {m}_{2} ; i ) ,$$

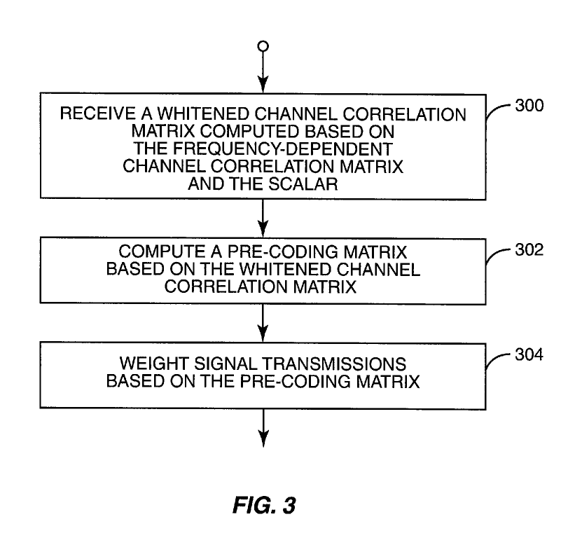

e.g., as illustrated by Step 300 of FIG. 3.

A pre-filter weight calculator 162 included in or associated with the transmitter baseband processor 160 computes the pre-coding matrix \tilde{W}(f) based on the whitened channel correlation matrix \tilde{H}(f; m₁, m₂), e.g., as illustrated by Step 302 of FIG. 3. In one embodiment, the transmitter baseband processor 160 derives eigenvectors Ψ from the whitened channel correlation matrix \tilde{H}(f; m₁, m₂) to compute the pre-coding matrix \tilde{W}(f) as given by equation (14) or equation (18). The transmitter baseband processor 160 then weights signal transmissions to the receiver 120 based on the pre-coding matrix \tilde{W}(f), e.g., as illustrated by Step 304 of FIG. 3. This way, multiple signal streams can be emitted from the transmit antennas 130 with independent and appropriate weighting such that link throughput is maximized at the receiver 120.

Of course, other variations are contemplated. Thus, the foregoing description and the accompanying drawings represent non-limiting examples of the methods and apparatus taught herein for the transmission of system information. As such, the present invention is not limited by the foregoing description and accompanying drawings. Instead, the present invention is limited only by the following claims and their legal equivalents.

What is claimed is:

1. A method of feeding back channel state information from a receiver having two or more receive antennas spaced approximately λ/2 apart to a transmitter having two or more transmit antennas, the method comprising:
computing channel correlations for different combinations of the transmit antennas and each receive antenna;
averaging the channel correlations over the different receive antennas to form a frequency-independent channel correlation matrix;
computing a scalar representing noise variance at the receive antennas; and
feeding back the frequency-independent channel correlation matrix and the scalar for use in performing transmitter pre-coding computations.

2. The method of claim 1, wherein computing channel correlations for different combinations of the transmit antennas and each receive antenna comprises:
deriving channel estimates for different transmit and receive antenna combinations; and
long-term averaging the channel estimates over a plurality of frequency sub-carriers and a plurality of time slots.

3. The method of claim 1, further comprising averaging the scalar over frequency to make the scalar frequency-independent.

4. The method of claim 1, wherein computing the scalar comprises computing a scalar noise variance estimate for each of the different receive antennas.

5. The method of claim 1, wherein computing the scalar comprises forming a vector from diagonal components of a noise correlation matrix.

6. The method of claim 1, wherein feeding back the frequency-independent channel correlation matrix and the scalar for use in performing transmitter pre-coding computations comprises:
computing a whitened channel correlation matrix based on the frequency-independent channel correlation matrix and the scalar; and
transmitting the whitened channel correlation matrix to the transmitter for use in performing transmitter pre-coding computations.

7. The method of claim 6, wherein computing a whitened channel correlation matrix based on the frequency-independent channel correlation matrix and the scalar comprises:
scaling the channel correlations with the scalar when the noise variance at the receive antennas is not relatively the same; and
averaging the scaled channel correlations over the different receive antennas.

8. The method of claim 6, wherein computing a whitened channel correlation matrix based on the frequency-independent channel correlation matrix and the scalar comprises:
averaging the channel correlations over the different receive antennas when the noise variance at the receive antennas is relatively the same; and
scaling the averaged channel correlations with the scalar.

9. The method of claim 1, wherein feeding back the frequency-independent channel correlation matrix and the scalar for use in performing transmitter pre-coding computations comprises:
computing a pre-coding matrix based on the frequency-independent channel correlation matrix and the scalar; and
transmitting the pre-coding matrix to the transmitter.

10. The method of claim 9, wherein computing a pre-coding matrix based on the frequency-independent channel correlation matrix and the scalar comprises:
computing a whitened channel correlation matrix based on the frequency-independent channel correlation matrix and the scalar; and
deriving eigenvectors from the whitened channel correlation matrix.

11. A receiver, comprising:
two or more receive antennas spaced approximately λ/2 apart; and
a baseband processor configured to:
compute channel correlations for different combinations of transmit antennas and each receive antenna;
average the channel correlations over the different receive antennas to form a frequency-independent channel correlation matrix;
compute a scalar representing noise variance at the receive antennas; and
feed back the frequency-independent channel correlation matrix and the scalar for use in performing transmitter pre-coding computations.

12. The receiver of claim 11, wherein the baseband processor is configured to derive channel estimates for different transmit and receive antenna combinations and long-term average the channel estimates over a plurality of frequency sub-carriers and a plurality of time slots to compute the channel correlations.

13. The receiver of claim 11, wherein the baseband processor is configured to average the scalar over frequency to make the scalar frequency-independent.

14. The receiver of claim 11, wherein the baseband processor is configured to compute a scalar noise variance estimate for each of the different receive antennas.

15. The receiver of claim 11, wherein the baseband processor is configured to compute the scalar by forming a vector from diagonal components of a noise correlation matrix.

16. The receiver of claim 11, wherein the baseband processor is configured to:
compute a whitened channel correlation matrix based on the frequency-independent channel correlation matrix and the scalar; and
transmit the whitened channel correlation matrix for use in performing transmitter pre-coding computations.

17. The receiver of claim 16, wherein the baseband processor is configured to:
scale the channel correlations with the scalar when the noise variance at the receive antennas is not relatively the same; and
average the scaled channel correlations over the different receive antennas to compute the whitened channel correlation matrix.

18. The receiver of claim 16, wherein the baseband processor is configured to:
average the channel correlations over the different receive antennas when the noise variance at the receive antennas is relatively the same; and
scale the averaged channel correlations with the scalar to compute the whitened channel correlation matrix.

19. The receiver of claim 11, wherein the baseband processor is configured to:
compute a pre-coding matrix based on the frequency-independent channel correlation matrix and the scalar; and
transmit the pre-coding matrix.

20. The receiver of claim 19, wherein the baseband processor is configured to:
compute a whitened channel correlation matrix based on the frequency-independent channel correlation matrix and the scalar; and
derive eigenvectors from the whitened channel correlation matrix to form the pre-coding matrix.

21. A method of transmitting signals via two or more transmit antennas, comprising:
receiving a whitened channel correlation matrix computed based on a scalar and a frequency-independent channel correlation matrix, the frequency-independent channel correlation matrix representing channel correlations averaged over different receive antennas for different combinations of the transmit antennas as observed at each receive antenna and the scalar representing noise variance at the different receive antennas;
computing a pre-coding matrix based on the whitened channel correlation matrix; and
weighting signal transmissions based on the pre-coding matrix.

22. The method of claim 21, wherein computing a pre-coding matrix based on the whitened channel correlation matrix comprises deriving eigenvectors from the whitened channel correlation matrix.

23. A transmitter comprising:
two or more transmit antennas; and
a baseband processor configured to:
receive a whitened channel correlation matrix computed based on a scalar and a frequency-independent channel correlation matrix, the frequency-independent channel correlation matrix representing channel correlations averaged over different receive antennas for different combinations of the transmit antennas as observed at each receive antenna and the scalar representing noise variance at the different receive antennas;
compute a pre-coding matrix based on the whitened channel correlation matrix; and
generate signal transmission weights based on the pre-coding matrix.

24. The transmitter of claim 23, wherein the baseband processor is configured to derive eigenvectors from the whitened channel correlation matrix to compute the pre-coding matrix.
